(19) United States
(12) Patent Application Publication
(10) Pub. No.: US 2006/0207715 A1
(43) Pub. Date: Sep. 21, 2006

(54) Method, and consequent product, for the creation of decorative glass plates that are resistent to knocks and thermal shocks

(76) Inventor: Gianfranco Barban, Milan (IT)

Correspondence Address: STITES & HARBISON, PLLC, 400 W MARKET ST, SUITE 1800, LOUISVILLE, KY, 40202-3352, US

(21) Appl. No.: 11/375,451

(22) Filed: Mar. 14, 2006

(30) Foreign Application Priority Data
Mar. 15, 2005 (IT) VA/2005/A/0016

(51) Int. Cl. B32B 37/00; B32B 17/06; A47G 35/00

(52) U.S. Cl. 156/250; 428/426; 428/542.2

(57) ABSTRACT

The present invention concerns a method and the product obtained using said method for the creation of decorative plates of glass for use in building as a covering material for walls and floors and in furnishing for kitchen surfaces, bathroom furnishings and the like; the said plates being able to resist thermal shocks and knocks or, at the least, to minimize the effects of such thermal shocks and knocks, usually making repairs possible. The method essentially provides for shattering a plate of tempered glass in equipment suitable for holding the fragments in place, refilling at least part of the cracklings with adhesive and subsequently allowing that adhesive to harden. The resulting product is characterized in that it comprises a plurality of glass fragments bonded together by means of the afore-mentioned adhesive, which at least partially fills the space existing between said fragments.

The present invention concerns a method and the product obtained using said method for the creation of decorative plates of glass for use in building as a covering material for walls and floors and in furnishing for kitchen surfaces, bathroom furnishings and the like; said plates being able to resist thermal shocks and knocks or, at the least, to minimize the effects of such thermal shocks and knocks, usually making repairs possible.

Glass is particularly suitable, because of its transparent and glossy characteristics, to creating decorative articles of notable quality. In particular, a tempered plate that is shattered while keeping the fragments in place acquires an excellent brilliance, since the many surfaces of the fragments produce shimmering and countless reflections.

Particular decorative effects are obtained using the well-known technique in which three glass plates are joined together with a film of PVB, or something similar, in between, as in the stratification of security glass. Between the two external plates, one of previously tempered glass is placed; the panel thus formed is grounded perimetrically to finish the edges. This working causes the tempered glass to shatter (crackle). The adherence of the glass fragments to the external plates is assured by the PVB, which holds the panel together. In this way, one has fragmentation of the tempered plate without any shifting of the fragments.

On the other hand, to obtain gaps between said fragments, there is a well-known technique, which allows obtaining plates that have been shattered and reconstructed using an adhesive, said plates being contained between plates of glass.

In none of the known cases were plates which had been shattered and reconstructed individually, that is not contained between other plates, successfully obtained, which thus precludes the possibility of having thin plates.

Glass is a notoriously brittle material and is thus liable to break under mechanical actions, even if the latter are not too intense. Even thermal actions, such as intense and localized heating, make glass, precisely because of its characteristic brittleness, particularly subject to breaking.

Technological development has led to the creation of high-resistance glass, which shows exceptional characteristics of resistance to both knocks and heat. The tempering treatment greatly increases resistance to knocks, just as a particular type of glass, called pirex, has a resistance to heat high enough to actually allow its use for pots and pans which can be placed directly over the flame. Furthermore, the combining of more glass plates with the interposition of sheets of polymeric material, for example polyvinyl butyraldehyde (PVB), makes possible the creation of such afore-mentioned security glass, able to resist smashing and gun shots. Glass of this type is commonly used for windshields and armoured bulletproof windows.

In any case, the possibility still remains that glass, even of the high-resistance variety, will break and in such a case, obviously, will break in a precise way. In the case where tempered glass is involved, it crumbles completely and so any attempt to repair it is absolutely impossible, while if stratified security glass is involved, the various fragments remain in place, but without hope of repair, if not in extremely unusual cases, that is in the case of extremely localized breaks without fractures prone to further cracking. In such cases, it is usually sufficient to insert a low-viscosity adhesive, for example an acrylic resin that can be cross-linked with ultra-violet light, into the cracks to obtain an almost perfect repair. In cases where the fractures are susceptible to further cracking, no repairs would prove effective in that the crack tips would remain nonetheless a weak point and a focusing point for stresses, because of which the cracks would continue to propagate.

As far as resistance to thermal shocks is concerned, even if pirex glass performs very well, it is not suitable to make objects with plates of particularly substantial dimensions.

The aim of the present invention is to propose a method and the object deriving from the use of said method, respectively according to claims 1 and 13, for making decorative glass plates able to provide aesthetic effects of high quality, for use in furnishings and construction, said plates being, among other things, resistant to thermal shocks and localized knocks, and usually repairable in cases of breaks.

The object that derives from the use of the method according to the invention, is a plate formed by a large quantity of fragments, held together by an adhesive which re-establishes integrity. A plate of this type is not normally able to sit directly over a flame like pirex glass, as the resins normally used are not able to resist high temperatures, but it is without a doubt able to have even hot objects placed on it, since the dilatation caused by localized heating is absorbed by the resin. Furthermore, any breaks which might involve the article, obviously if of slight extent, would however be easily repaired because fractures susceptible to further cracking would not be produced.

The resistance to heat is thus inferior to that of pirex glass, just as the resistance to knocks is inferior to that of tempered glass; nevertheless, as will be seen in the following description, in its use as tiles for floors and covering for building, and as a surface material for kitchens and sinks, the conditions of normal use are not very harsh. However, situations can occur in which glass of a known type is subject to breaks to a greater extent and, moreover, in such a way that repairs are impossible, while a glass plate according to the invention is, should it break, almost always repairable.

The invention will now be described with an illustrative, not restrictive, aim in mind and with reference to the attached figures, in which:

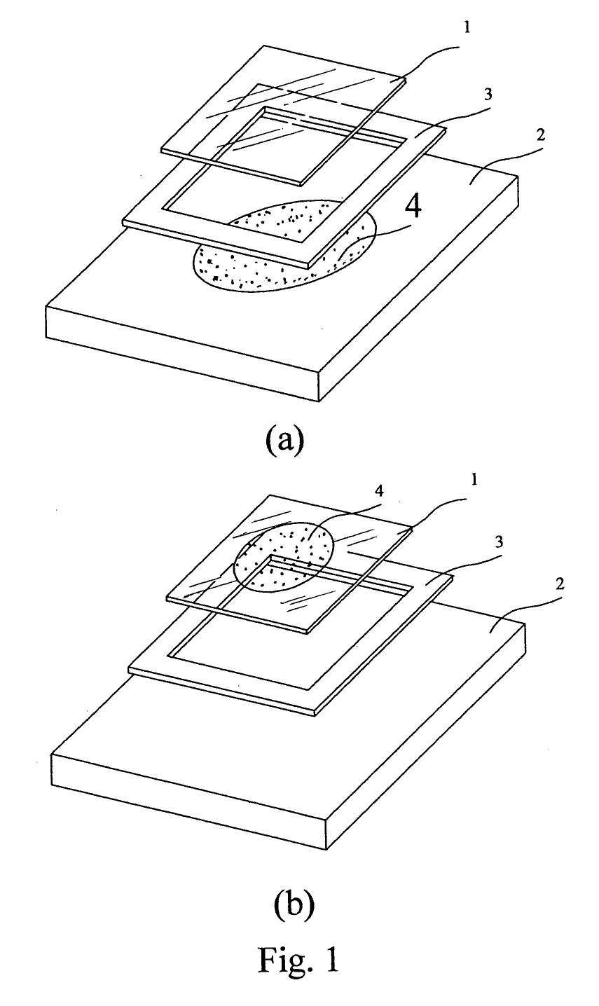

FIGS. 1(a, b) briefly illustrate the method according to the invention;

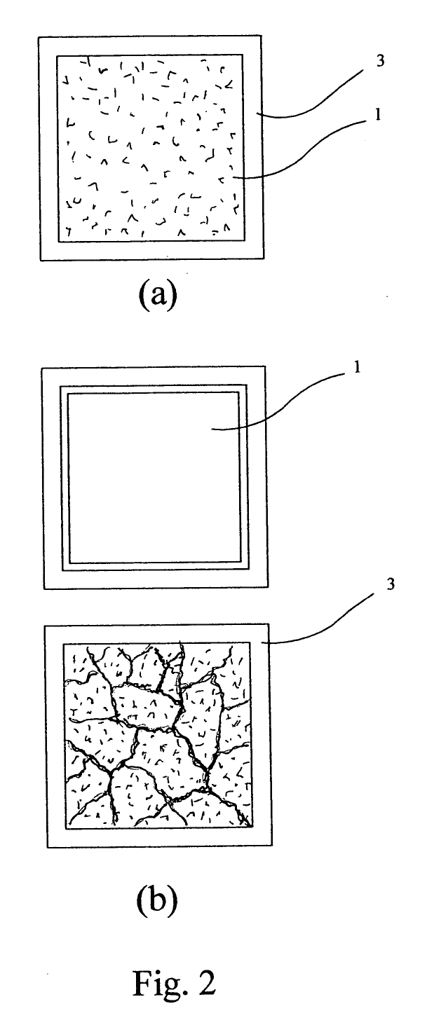

FIGS. 2(a, b) show the procedure to obtain shattered plates with and without gaps forming;

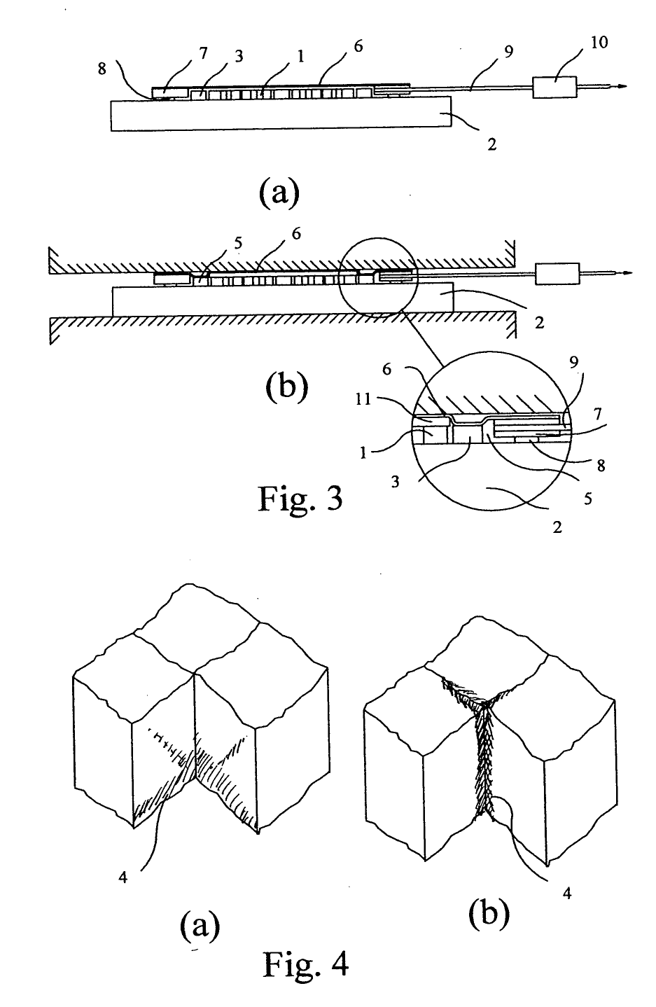

FIGS. 3(a, b) illustrate both vacuum and press procedure, for obtaining plates, according to the invention;

FIGS. 4(a, b) show the insertion of adhesive in the cracklings of the shattered plates;

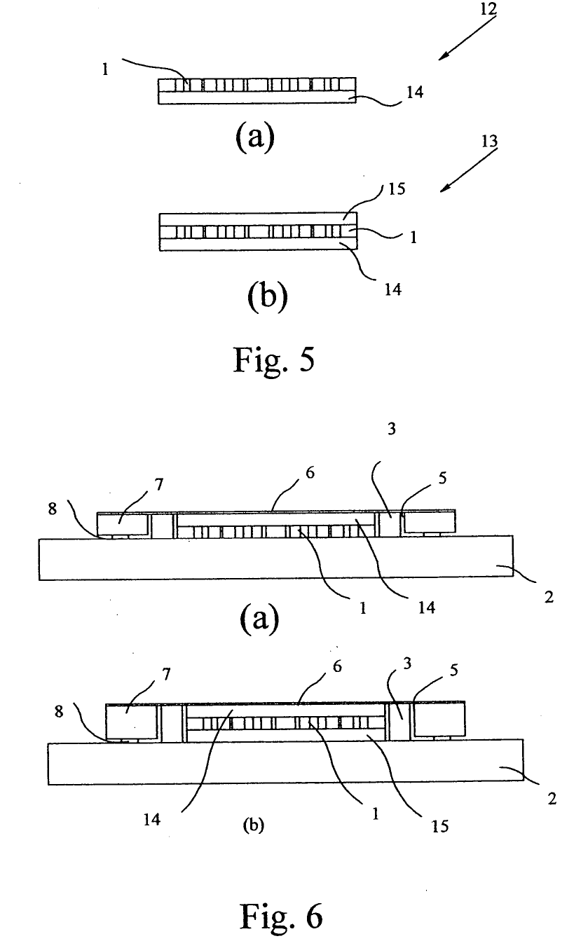

FIGS. 5(a, b) show the plates obtained by joining the plate, according to the invention, to other plates;

FIGS. 6(a, b) illustrate the method for obtaining the afore-mentioned coupled plates.

The method, according to the invention, briefly illustrated in FIGS. 1(a, b), essentially consists of shattering a plate of tempered glass (1), laying on a surface (2), and preferably contained within a frame (3) which prevents the fragments from dispersing, and of reconstructing the integrity of the plate with an adhesive (4) which enters into the cracks.

The afore-mentioned adhesive (4), for example an acrylic resin that can be cross-linked with ultra-violet light, or an epoxy resin with hardener, or else a polyester resin with catalyst, can be smeared beforehand on the supporting surface (2), as shown in FIG. 1a, in which case it will rise again through the cracks, since the glass fragments, having a higher density than the adhesive, will tend to sink in the same. Alternatively, the adhesive (4) can be smeared on top of the said plate (1), as shown in FIG. 1b, in which case it will fall, due to gravity, through the cracks.

In both cases, the supporting surface (2), if not made from a material to which the chosen adhesive can not adhere, such as PTFE, UHMWPE, or UHMWPET, must be treated with a release substance or else covered with a sheet of an intrinsically release material.

The aforesaid frame (3) should be of such dimensions as to perfectly contain the plate (1) (FIG. 2a), in which case the fragments, after the plate's shattering (1), will stay in place; or else (FIG. 2b), the frame (3) can be of larger dimensions. In such a case, it will be possible to arrange the fragments in such a way so as to obtain decorative gaps.

In practice, one proceeds in the following way:
On a supporting surface (2), either releasing or made so by the use of suitable means, the adhesive is smeared (4);
On top of said adhesive (4), the plate (1) is placed, exercising enough pressure to make the adhesive flow in such a way as to cover the whole surface of the plate (1);
Around the plate (1), a frame is (3) placed;
The plate (1) is fractured, for example with a burin and a hammer;
In cases where the frame is of larger dimensions, the fragments are arranged, making them slide on the adhesive, in such a way as to form gaps;
The fragments are pressed towards the bottom to aid their sinking in the adhesive, and, hence, the resin's rising through the fractures;
The adhesive hardens, thus consolidating the plate (1);
The consolidated plate (1) is removed from the frame (3).

In order to improve the plate's consolidation (1) through a complete infiltration of the adhesive in the cracklings, it is preferable to remove the air present inside the cracklings themselves. As shown in FIG. 3a, this operation can be achieved through the creation of a chamber (5) obtained for example through a membrane (6) applied to a external frame (7) which creates a seal with the supporting surface (2) through a continuous gasket (8), the said chamber (5) being placed in communication, through a pipe (9), with a vacuum pump (10). In this way, removing the air contained in the chamber (5), the plate (1) will be subjected to atmospheric pressure and so will be pressed against the supporting surface (2). At the same time, the removal of the air present in the cracklings makes filling the latter with adhesive easier. In addition to the push from atmospheric pressure, the whole group, consisting of the supporting surface (2), the plate (1), the frame (3) and the air chamber (5), can be inserted between the plates of a press for an even better consolidation, as shown in FIG. 3b. This further operation can be useful in the case where the possibility exists that some fragments of the plate (1) undergo rotation or excessive movement, which hinders the reconsolidation of the plate. In this case, the atmospheric pressure might not be enough and thus necessitates the use of a press. In such case it is advisable to insert between the plate (1) and the membrane (6) a plate (11), for example of sheet metal, obviously treated with a releasing substance or with the interposition of a thin sheet of release material. In the enlargement of FIG. 3b a detail of the upper press plate is shown urging on membrane (6) deformed by atmospheric pressure that makes it to lie on the frame (3).

A possible variation (not shown) to the procedures described can be to keep upwards the part that stays in sight. This procedure can be advisable in the case of very small series or single pieces for which particularly accurate equipment would not be economically reasonable. Indeed, in this case, it is possible that air bubbles in the gaps and/or more or less empty gaps would remain. In such a case it is possible to refill the said gaps manually to eliminate the effects of the air bubbles.

Regarding the filling of the cracklings, it must be said that their complete refilling greatly reduces the brilliance of the glass, since it is the presence of numerous reflecting surfaces that causes the desired glitter; hence for the best aesthetic result, it is advisable to refill the cracklings only in part, said partial refilling being possible with an adhesive that rises only in part or else that rises through some routes and not others, fixing the fragments in place all the same. FIG. 4a shows the adhesive (4), which rises in the cracklings among the plate's (1) fragments to only a fraction of their thickness, while FIG. 4b shows the adhesive, which rises in the cracklings through the plate's (1) fragments through the whole thickness of said fragments but along only some routes. Obviously the refilling of the gaps obtained by separating the fragments is, however, complete.

The correct refilling of the cracklings can be achieved with the correct choice of the adhesive's viscosity and of the time of the application of pressure and vacuum.

If, for reasons that will be illustrated in the following text, one desires to fill the cracklings completely or almost completely, it would be best, regardless of the fluidity of the adhesive, to apply either some pressure and vacuum, while in the case where one wants to maintain a high level of brilliance and hence not completely fill the cracklings, it can be sufficient to apply pressure with a press, without vacuum.

The plate obtained through the method described can be used individually or can in turn be joined to a second and third plate to obtain plates of two (12) (FIG. 5a) or three (13) (FIG. 5b) joined plates.

To have a coupled plate of type (12), the reconstructed plate (1) can be joined to a second plate (14) of equal dimensions. In the case where the afore-mentioned coupled plate (12) is to be used as a tile for floors and covering, the aforesaid second plate (14) can be of brick, while in the case of the coupled plate's use for decorative windows, walls, or doors, said second plate (14) can be in glass, if the window must be transparent, or else in sheet-metal, for example in aluminium or stainless steel, when transparency is not necessary.

For a coupled plate of type (13), the reconstructed plate (1) can be bonded in such a way as to be included between the afore-mentioned second plate (14) and a third glass plate (15).

The bonding of said second (14) and third (15) plates to the first (1) can occur either after said first plate (1) has been shattered and reconstructed according to the procedure described or during the process of formation of said shattered and reconstructed plate (1).

FIGS. 6(a, b) show respectively the plans of formation of said coupled plates (12) and (13). Obviously in these cases means for releasing the first plate (1) from the second and third, (14) and (15), should not be used.

In the case of coupled plate type (12), it must be remembered that, should gaps form in the plate (1), the withdrawal of the adhesive in the gaps can cause a contraction in the plate itself, with the consequence that the coupled plate (12) could end up deformed. In such cases, it is necessary to use adhesives with minimal or no withdrawal, such as, for example, acrylic resins that harden with ultra-violet light or epoxies with high percentages of force.

The aforesaid third plate (15) can in turn be of tempered and shattered glass with or without gaps.

The surfaces of the first plate (1), in the case of a plate that has been shattered and reconstructed individually, the external surface of the plate (1), in the case of coupled plates (12); and the external surface of the third plate (15) in the case of coupled plates (13) and of a shattered third plate (15), can advantageously undergo grinding and, possibly, polishing, obtaining thusly surfaces that are perfectly smooth and of a desirably finishing. For example, a grinding that leaves surfaces glazed can be advisable for floor tiles in order to avoid slippery surfaces. In the case of cracklings that are not completely filled with adhesive, treatment with a suitable impregnating substance could be advisable in order to avoid the infiltration of liquids that could affect the aesthetic aspect.

If the upper plate, whether it involves the afore-mentioned third plate (15) or the first plate (1), in the case of coupled plates of, respectively, type (13) or (12), should be shattered and with its cracklings completely refilled with adhesive, it would be practically indistinguishable from a intact plate. This operation would have however notable functional advantages. In the case of use for making kitchen surfaces, this operation makes said plates (15) and (1) practically immune to localized heating, obviously within the limits of cases that can occur in a domestic kitchen, such as, for example, those caused by setting down pots and pans just removed from the flame. Indeed, the localized dilatation is absorbed by the adhesive, which thus averts the risk of cracks. Moreover the fact that the cracklings are completely refilled prevents even the risk of infiltrations that can alter the aesthetic appearance.

Said shattered plates with cracklings that are completely refilled with adhesive offer a further advantage. In the case of use as floor tiles, that is heavier use regarding the falling of heavy, denting bodies, the possible breaking caused by said falls concerns only the zone immediately around the point of impact, impeding the propagation of cracks. This fact has the important consequence of making it possible to almost always repair the plate affected by the break, proceeding in a method similar to the repair of a car windshield, inserting, that is, an acrylic resin that can be cross-linked with ultra-violet light.

In order to obtain particularly high levels of thickness, with a marked effect of depth, it is possible to bond even more than three plates, until reaching desired aesthetic and/or functional effect. The formation of such coupled plates of more than three plates can be done either during the formation of the first plate (1), as in the case of the coupled plates of type (12) and (13), or subsequently attaching as wished the desired number of shattered and reconstructed plates or of intact plates.

A possible variant of the method described consists of sucking the air completely out of the chamber (5) and the injection of the adhesive following this operation (4). In this way, it is practically impossible to find some air left, since the air itself has been completely removed before the adhesive injection, and it is the adhesive itself that, passing through the fractures, helps the removal of the remaining air, which has not been removed by the vacuum pump yet.

Anyway, since the plates are obtained through a airless and/or press process, practically, said first plate (1) could be considered in contact with the second plate (14), in case of plates paired up per type (12), and also with said third plate (15), in case of plates paired up per type (13), since in this case the thickness of the interposed adhesive is quite thin.

The invention has been described with a purely illustrative and not limiting goal in mind. The sector's technical expert will be able to find numerous variations, all falling under the protection of the claims that follow.

1. Method for creating decorative glass plates for use in building as a covering material for walls and floors and in decoration for kitchen surfaces, bathroom furnishings and the like, of the kind which provides for the shattering of a tempered glass plate and the reconstructing of the plate itself by using an adhesive, characterized by the fact that it provides for the following phases:
the shattering of a tempered glass plate in equipment suitable for holding the fragments in place;
the refilling at least in part of the fragments with adhesive;
the hardening of said adhesive.

2. Method according to claim 1, characterized in that said equipment, suitable for holding the fragments in place is a frame (3) which is larger than the said intact plate (1), in such a way as to allow the movement of the fragments to create decorative gaps, said gaps being at least partially refilled with adhesive (4).

3. Method according to claim 1, characterized in that said equipment, suitable for holding the fragments in place is a frame (3) of dimensions equal to those of the intact plate, in such a way as to prevent the fragments' movement.

4. Method according to claim 1, characterized in that it provides for the following phases:
the placing of an adhesive layer (4) on a supporting surface (2) after spreading a suitable releasing agent;
the placing of a first tempered glass plate (1) on said adhesive (4), said first plate (1) being contained in a suitable equipment (3);
the shattering of said first plate (1);
the placing of equipment suited for creating a vacuum chamber (5) over said fractured first plate (1);
the removal of air from inside the aforesaid vacuum chamber (5), exercising pressure on the afore-mentioned shattered first plate (1) to keep it attached to the supporting surface (2) and to favour the penetration of the adhesive (4) in the spaces between the fragments of the said shattered first plate (1);
the hardening of the adhesive (4);
the removal of the consolidated article from the supporting surface (2).

5. Method according to claim 1, characterized in that it provides for the following phases:
the spreading of a layer of adhesive (4) on a supporting surface (2) after spreading a suitable releasing agent;
the placing of a first plate of tempered glass (1) on the aforesaid adhesive, said first plate (1) being contained in suitable equipment (3);
the shattering of said first plate (1);
the application of pressure on said shattered first plate (1) to keep it attached to said supporting surface (2) and to encourage the penetration of the adhesive (4) in the spaces between the fragments;
the hardening of the adhesive (4);
the removal of the consolidated article from the supporting surface (2).

6. Method according to claim 1, characterized in that it provides for the following phases:
the spreading of a layer of adhesive (4) on a supporting surface (2) after spreading a suitable releasing agent;
the placing of a first plate of tempered glass (1) on the aforesaid adhesive, said first plate (1) being contained in suitable equipment (3);
the shattering of said first plate (1);
the placing of equipment suited to creating a vacuum chamber (5) on top of the aforesaid shattered first plate (1);
the removal of air from inside said vacuum chamber (5), exercising pressure on the aforementioned shattered first plate (1) to keep it attached to the supporting surface (2) and to encourage the penetration of the adhesive (4) in the spaces between the fragments;
the application of pressure on the aforesaid shattered first plate (1) with a press to keep it attached to the afore-mentioned supporting surface (2), to encourage the penetration of adhesive (4) in the spaces between the fragments and to reduce the thickness of the adhesive (4) left on the surfaces of said first plate (1);
the hardening of the adhesive (4);
the removal of the consolidated article from the supporting surface (2).

7. Method according to claim 1, characterized in that it provides for the following phases:
the placing of a first tempered plate (1) on a supporting surface (2) after spreading a suitable releasing agent, said first plate (1) being contained in a suitable equipment (3);
the shattering of said first plate (1);
the placing of equipment suited for creating a vacuum chamber (5) over said shattered first plate (1);
the removal of air from inside the afore-mentioned vacuum chamber (5);
the adhesive (4) injection inside of the aforesaid vacuum chamber (5);
the application of pressure on said shattered first plate (1) to keep it attached to the supporting surface (2) and to encourage the penetration of the adhesive (4) in the spaces between the fragments;
the hardening of the adhesive (4);
the removal of the consolidated article from the supporting surface (2).

8. Method according to claim 4, characterized in that it provides for the application of pressure, by a press, on said shattered first plate (1) to keep it attached to the supporting surface (2), to encourage the penetration of the adhesive (4) in the spaces between the fragments and to reduce the thickness of the adhesive (4) left on the surface of said first plate (1).

9. Method according to claim 4, characterized in that it provides for an arrangement of the fragments of said first plates to create gaps.

10. Method according to claim 4, characterized in that it provides for the placing of a second plate (14) on top of said first plate (1), with the interposition of adhesive (4) between said first plate (1) and second plate (14).

11. Method according to claim 4, characterized in that it provides for a grinding of the surface of said first plate (1).

12. Method according to claim 4, characterized in that between the aforesaid supporting surface (2) and the said first plate (1) to be shattered is placed a third glass plate (15), so that the adhesive (4) destined to refill at least partially the spaces between the fragments is placed directly on said third plate (15).

13. Method according to claim 12, characterized in that the afore-mentioned third glass plate (15) is shattered.

14. Method according to claim 13, characterized in that said third shattered glass plate (15) is superficially grinded.

15. Method according to claim 4, characterized in that the aforesaid first plate (1) and possible second (14) and third plates (15) are placed on the afore-mentioned supporting surface (2) in such a way that the article obtained has its side, which following the finally assembly remains in sight, turned upwards.

16. Method according to claim 1, characterized in that it provides for the refilling, with a suitable filling substance, of the cracklings present in the plate, which has been shattered (1) (15) and reconstructed with adhesive (4).

17. Decorative glass plate for use in building as a covering material for walls and floors and in decoration for kitchen surfaces, bathroom furnishings and the like, of the kind which provides for the shattering of a tempered glass plate and the reconstructing of the plate itself with adhesive, characterized in that it comprises a plurality of glass fragments bonded together by an adhesive that fills at least partly the spaces existing between said fragments.

18. Decorative glass plate, according to claim 17, characterized in that it is included between limiting elements.

19. Decorative glass plate, according to claim 17, characterized in that it is obtained with the method according to:
the shattering of a tempered glass plate in equipment suitable for holding the fragments in place;
the refilling at least in part of the fragments with adhesive;
the hardening of said adhesive.

20. Decorative glass plate, according to claim 17, characterized in that the aforesaid spaces between the afore-mentioned fragments are at least in part of a size to distinguish gaps, partially refilled with hardened adhesive.

21. Decorative glass plate, according to claim 17, characterized in that said spaces between said fragments have a thickness, which is practically null.

22. Decorative glass plate, according to claim 17, characterized in that it is coupled to a second plate (14), in order to obtain a coupled plate (12), in which said plate (1), shattered and reconstructed, results to be external.

23. Decorative glass plate, according to claim 22, characterized in that it is coupled to a third plate (15), in order to obtain a coupled plate (13), in which said plate (1), shattered and reconstructed, results included between said second plate (14) and third plate (15).

24. Decorative glass plate, according to claim 22, characterized in that that said first plate (1) touches the said second plate (14).

25. Decorative glass plate, according to claim 23, characterized in that said first plate (1) touches the said second plate (14) and the said third plate (15).

26. Decorative glass plate, according to claim 23, characterized in that the said third plate (15) is shattered without movement of the fragments.

27. Decorative glass plate, according to claim 23, characterized in that the said third plate (15) is shattered with movement of the fragments so as to create gaps.

28. Decorative glass plates, according to claim 26, characterized in that the spaces between the fragments of said shattered third plate (15) are at least partially refilled with adhesive.

29. Decorative glass plate, according to claim 26, characterized in that the spaces between the fragments of said shattered third plate (15) are at least partially refilled with a filling substance.
